(19) United States
(12) Patent Application Publication
(10) Pub. No.: US 2019/0073800 A1
(43) Pub. Date: Mar. 7, 2019

(54) SYSTEM AND METHOD FOR SIMPLIFYING THE OPERATION OF A HOUSEHOLD APPLIANCE

(71) Applicant: BSH HAUSGERAETE GMBH, MUENCHEN (DE)

(72) Inventor: PETER LOCHNY, SYRGENSTEIN (DE)

(21) Appl. No.: 15/773,871

(22) PCT Filed: Oct. 28, 2016
(86) PCT No.: PCT/EP2016/076045

§ 371 Date: May 4, 2018

(30) Foreign Application Priority Data
Nov. 6, 2015 (DE) 10 2015 221 860.0

(51) Int. Cl. G06T 11/00

(52) U.S. Cl. CPC G06T 11/00; H04L 67/12

(57) ABSTRACT

A system for simplifying the operation of a household appliance includes a status transmitter for transmitting status data, which describes at least one aspect of a status of the household appliance, and a status receiver for receiving the status data from the status transmitter. A processing unit selects or creates visualizable data on the basis of the received status data, and a display device, which is configured to be placed in front of an eye of a user of the system, then displays the visualizable data. A method for simplifying the operation of a household appliance is also provided.

The present invention relates to a system for simplifying operation of a household appliance and to an associated method.

Household appliances such as dishwashers and washing machines, for instance, are not always easy to operate. They are usually supplied with lengthy user manuals providing information about their programs and their features. These manuals also explain maintenance steps needed to guarantee that the household appliances work properly and last a long time.

Since many users of household appliances do not read the user manual, the manufacturers of the household appliances try to make understanding the operation of the household appliances as intuitive as possible. This is why touch-sensitive operating displays, known as touch displays, have come to be used increasingly in recent years. There is also a trend towards networking the household appliances so that the household appliances can be controlled via tablet PCs or smart phones. This creates additional potential for more convenient user guidance, because more extensive information can be presented more comfortably to the user on tablet PCs.

US 2013/0086520 A1, for example, describes two apps for a smart phone that simplify the operation of a washing machine and a dishwasher. In the case of the washing-machine app, on his smart phone, the user can drag items of clothing into a virtual wash basket in order to indicate what the composition of the next wash load will be for the washing machine. The app then determines for the available washing machine an optimum wash program based on its type designation. The app for the dishwasher works in a similar manner. In this app it is possible to specify whether the dishwasher contains heavily soiled pans or just slightly dirty champagne glasses. Once again, an optimum cleaning program is determined from the load and the type of the filled dishwasher.

Proceeding from the prior art, an object of the present invention is to show a possibility for how the operation of a household appliance can be simplified further for the user.

This object is achieved according to the invention by the subject matter of the independent claims. The dependent claims define embodiments of the invention.

A fundamental idea of the present invention is to use status data of the household appliance to select and/or create visualizable data. This data is then displayed using a display device, which is designed to be arranged in front of an eye of a user of the system. What are known as smart glasses or contact lenses can be used for this purpose, for instance. One possible example is the HoloLens from Microsoft as described in US 2014/0160001 A1 for instance. It would also be possible to use a smart contact lens, as is currently being developed by Google.

The invention accordingly comprises a system for simplifying operation of a household appliance, which system comprises a status transmitter for transmitting status data that describes at least one aspect of a status of the household appliance, and a status receiver for receiving the status data from the status transmitter. On the basis of the received status data, a processing unit selects and/or creates visualizable data. The visualizable data is then displayed using a display device, which is designed to be arranged in front of an eye of a user of the system.

It is thereby possible to augment by virtual objects the user's perception of reality. Computer Science uses the terms “augmented reality” or else “virtual reality”, for example, to refer to this subject. The approaches described in that field, however, mostly do not take sufficient account of the current trend in which many everyday objects are now equipped with a comprehensive sensor system that makes it possible to describe the status of the visible appliances. Matching the viewed objects to a virtual representation of the object in the network is not trivial but technically feasible. This makes approaches possible that go far beyond the augmentation of the field of vision of the user considered until now.

Hence in a preferred embodiment, the system proposed here comprises a sensor system for detecting at least one aspect of the status of the household appliance, wherein the sensor system is preferably coupled to the status transmitter. The sensor system may comprise, for example, a camera, a barcode scanner, a temperature sensor, a humidity sensor, a microphone, an ultrasonic sensor, an accelerometer, a momentary-contact switch, a light curtain and/or a level indicator. A camera can be used, for example, to capture the interior of a refrigerator or of an oven. A barcode scanner permits scanning of purchased packaging so that it is hence possible to save what consumer item has been newly added and/or made available to a household appliance. For instance, a barcode scanner can be used to identify a purchased cheese or a package of a dishwasher tab. A temperature sensor can be used to show to the user the temperature in the oven. Deducing whether the dishes in the dishwasher have dried sufficiently yet is possible by means of a humidity sensor. A microphone allows the noises made by a washing machine during operation to be recorded, for example, in order to provide data for a fault analysis. It is thereby possible to identify in advance if parts subject to wear in the washing machine are approaching the end of their lifetime. Ultrasonic sensors, momentary-contact switches, light curtains or level indicators can be used to determine whether, for example, there is still enough coffee in the coffee machine. Accelerometers can determine whether the household appliance is standing straight, i.e. is on level ground. Particular advantages result from being able to combine this sensor system with the display device. It is thereby possible to make visible, circumstances that cannot be seen by natural means.

The status transmitter and/or the sensor system are preferably designed to be arranged in or on the household appliance. Alternatively, they can obviously also be connected already to the household appliance. For example, the sensor system can comprise a magnet or a clip so that it can be attached to the household appliance.

The system can also comprise an input device for entering at least one aspect of the status of the household appliance. The input device is preferably coupled to the status transmitter. For instance, a touch-sensitive display could be arranged on a refrigerator, which display depicts a menu in which the user just needs to tap on which food has been added to the refrigerator or removed from the refrigerator. The refrigerator can thereby know what food is being stored in it.

The status transmitter and the status receiver are preferably designed for wireless communication. For instance WLAN (also known as Wi-Fi), Thread (as currently being developed by the Thread Consortium (see threadgroup.org)), Bluetooth or ZigBee could be used.

In some embodiments, the processing unit is coupled to a memory unit for storing a reference status of the household appliance. By comparing the received status data with the reference status, the processing unit can then determine a deviation from the reference status. This comparison result can then be used to select and/or create the visualizable data that is most appropriate. For example, the refrigerator could ascertain those food items that it lacks and display a shopping list to the user. Or the dishwasher can indicate that it is necessary to replenish salt or rinse aid.

In some embodiments, the display device is designed to identify a gaze direction of the user, and to display the visualizable data with reference to a normal field of vision of the user in such a way that the user can recognize that the visualizable data belongs to the household appliance. In everyday language, this physical association can also be described as pinning virtual data to objects.

The display device and/or the processing unit can be designed to recognize a gesture of the user. The visualizable data can then preferably depend on the recognized gesture. The gesture can both have a connection to the visible environment and also be detached therefrom. For instance, a gesture can be performed in front of an object, with the gesture representing an instruction that then relates to the object. It is also possible, however, for set gestures, which initiate a certain action irrespective of the environment, to be fixed with the system.

The display device can be formed by a pair of glasses, for example, which is at least partially transparent. A possible example here is the HoloLens from Microsoft. In an alternative embodiment, the display device is formed by a smart contact lens, such as Google is working towards, for example. It is also possible to use a display device comprising a non-transparent display and a camera. In this case, the camera captures what the user would see without the display, and shows this on the display, with virtual objects augmenting what is shown.

The household appliance may be a refrigerator, for example. In this case, the visualizable data can relate to food, for instance, that is not currently in the refrigerator and hence the user is meant to buy. Thus if the user looks at his refrigerator, a shopping list could be shown to him on the display device in order to remind him what still needs to be bought. Alternatively or additionally, a camera can be arranged in the refrigerator. When the user looks at his refrigerator, the contents of the refrigerator can be displayed to the user without the user having to open the refrigerator. This reduces cooling losses from the refrigerator.

The household appliance may also be a cooktop. In this case it makes sense for the visualizable data to relate to a hot zone of the cooktop. The hot zone can be outlined in red, for instance. Obviously it is also possible that the visualizable data relates to cooking instructions. It is possible to show both recipes and tips for operating the cooktop, in particular with a direct reference to a displayed recipe.

An oven can also be incorporated in the system. The visualizable data then preferably relates to an image of an interior of the oven or to a prevailing temperature in the oven. For example, a camera can be arranged in the oven so that the user can monitor a degree of browning of the item to be baked without having to be in the immediate vicinity of the oven.

Another possible household appliance is an extractor hood. The visualizable data can then relate to maintenance advice, for example, or even to a current status of the extractor hood such as, for instance, the present fan setting. For example, the extractor hood can give a reminder that the filter requires cleaning.

A dishwashing machine can also be integrated in the proposed system. The dishwashing machine could have a camera, for example, and the dishwasher would be able to detect from the images from the camera when it is almost full so that it can notify the user that ideally the user should start the dishwashing. Information that a cleaning process has finished can also be given to the user. It is also possible that the user, when viewing the interior of the dishwasher, is given maintenance advice such as, for example, advice that salt requires replenishing, rinse aid requires replenishing or a filter requires cleaning.

Obviously it is equally possible that the household appliance is embodied as a washing machine. In the case of a washing machine it is again possible, for example, to notify that a cleaning process has finished or to display maintenance advice.

In some embodiments, the visualizable data relates to a fill level of an operating medium or to a fill level of a waste container. It could be displayed, for instance, that the rinse aid in the dishwashing machine is running out or that the coffee beans in the coffee machine will soon be used up. It is equally possible that the vacuum cleaner indicates that its dust bag is almost full, or that the coffee machine lets the user know that the coffee dregs container should be emptied.

Of course it is also possible to combine all the household appliances mentioned in one system. The stated features can be combined with one another in any way to form a system that is optimized for the application.

In addition to the system presented here, the present invention also comprises a method for simplifying operation of a household appliance, which method can make use of the described system. According to the method, a display device is first arranged in front of an eye of a user of the household appliance. Status data that describes at least one aspect of a status of a household appliance is transmitted to a status receiver. Visualizable data is then selected and/or created on the basis of the status data received by the status receiver. This visualizable data is then displayed on the display device.

Unless stated otherwise, the statements made relating to the system apply analogously to the method. This can mean in particular that the method according to the invention comprises embodiments containing steps that make use of and/or implement or support the system features.

Further details and advantages of embodiments of the present invention are explained with reference to the figures, in which:

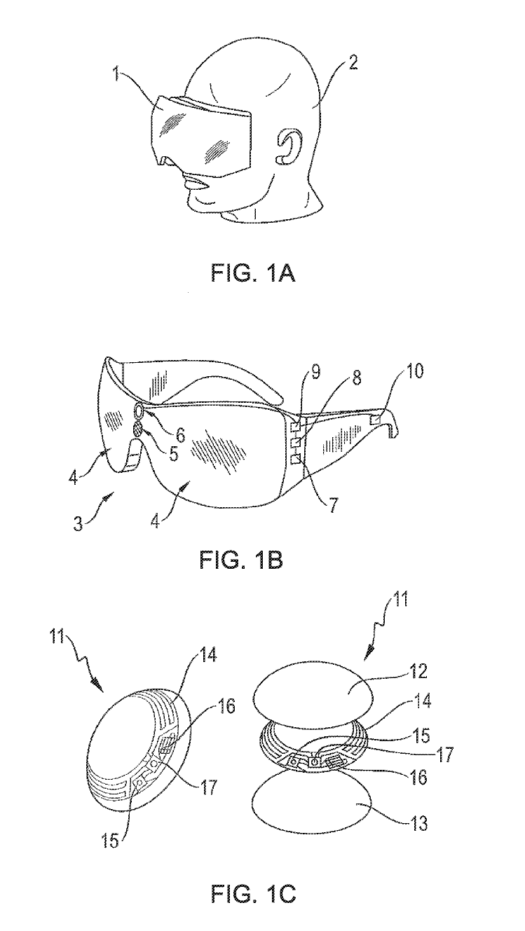

FIG. 1a shows a first embodiment of a display device;

FIG. 1b shows a second embodiment of a display device;

FIG. 1c shows a third embodiment of a display device;

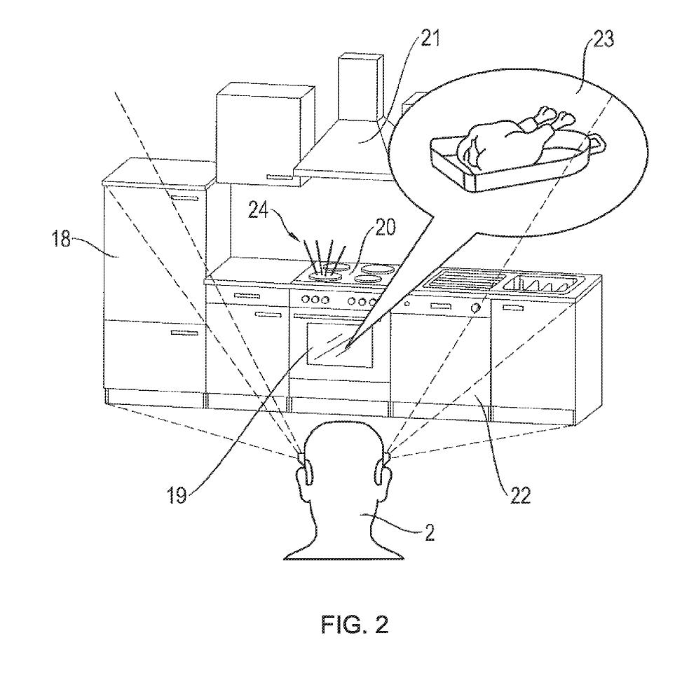

FIG. 2 shows a first example of an augmented field of vision of a user;

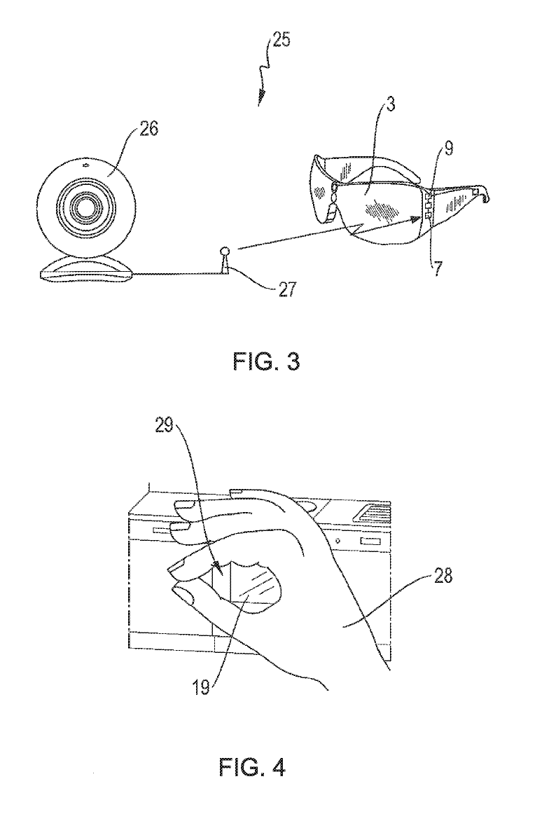

FIG. 3 shows a first embodiment of a system according to the invention;

FIG. 4 shows a first example of a gesture;

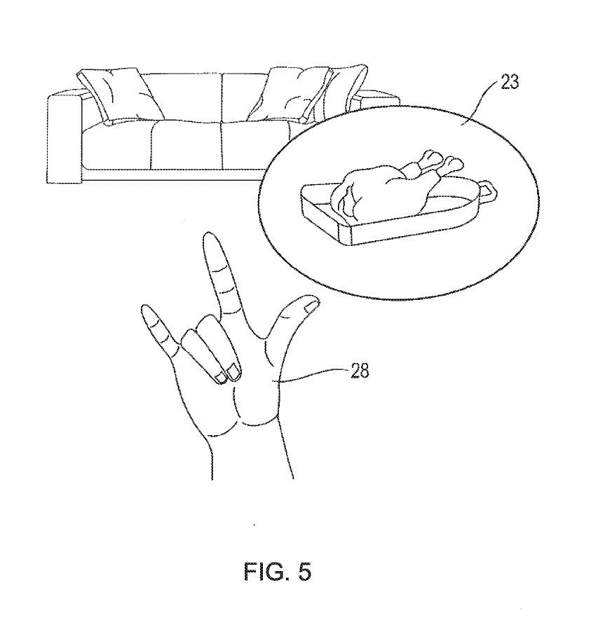

FIG. 5 shows a second example of a gesture;

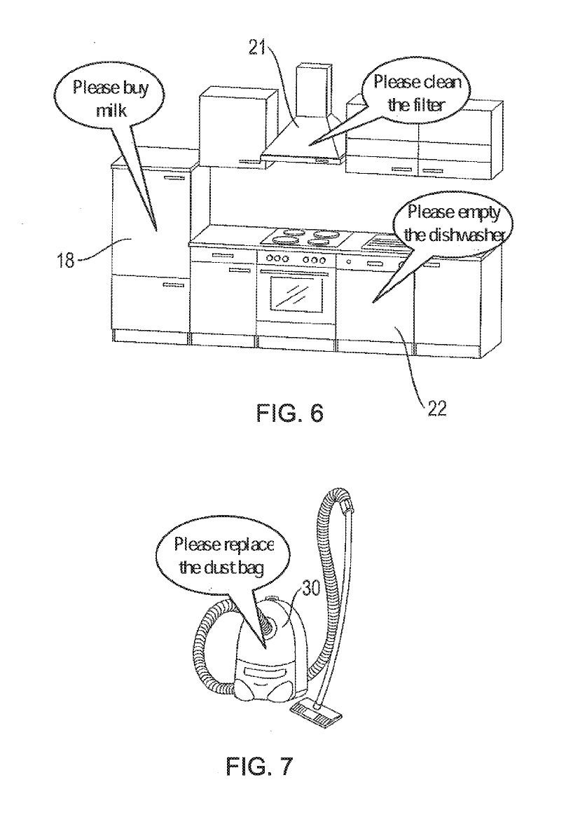

FIG. 6 shows a second example of an augmented field of vision of a user;

FIG. 7 shows a third example of an augmented field of vision of a user;

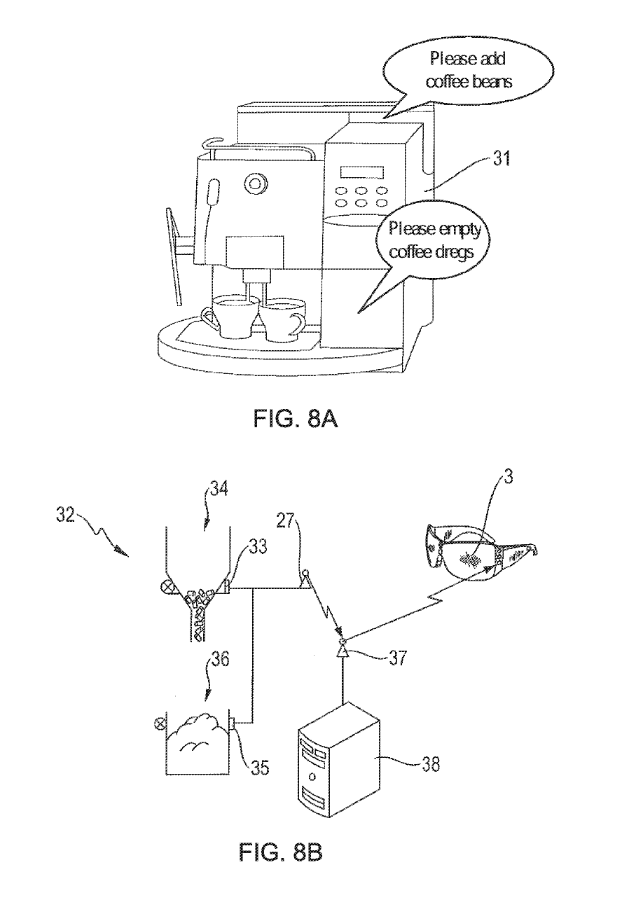

FIG. 8a shows a fourth example of an augmented field of vision of a user;

FIG. 8b shows a second embodiment of a system according to the invention;

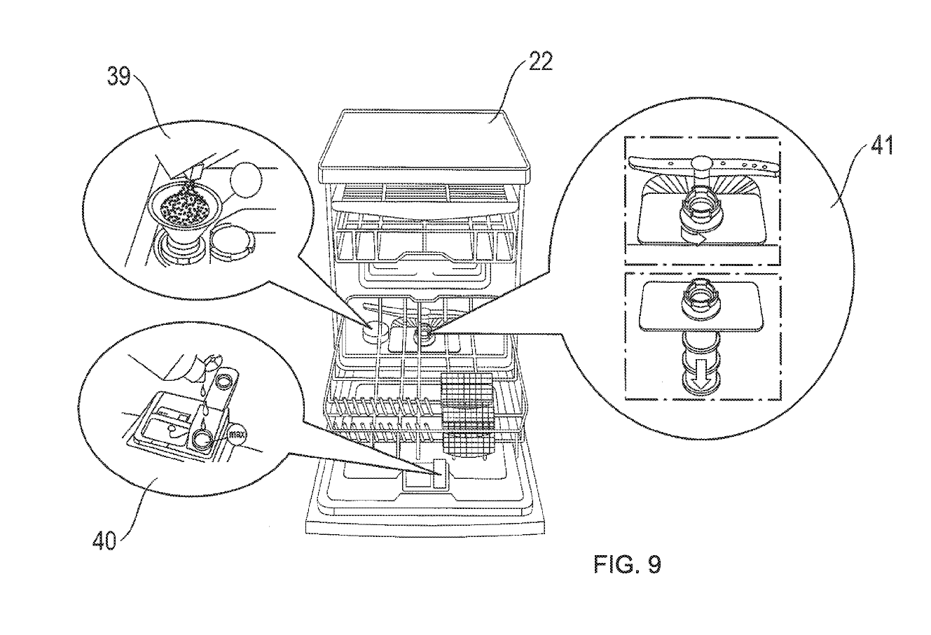

FIG. 9 shows a fifth example of an augmented field of vision of a user;

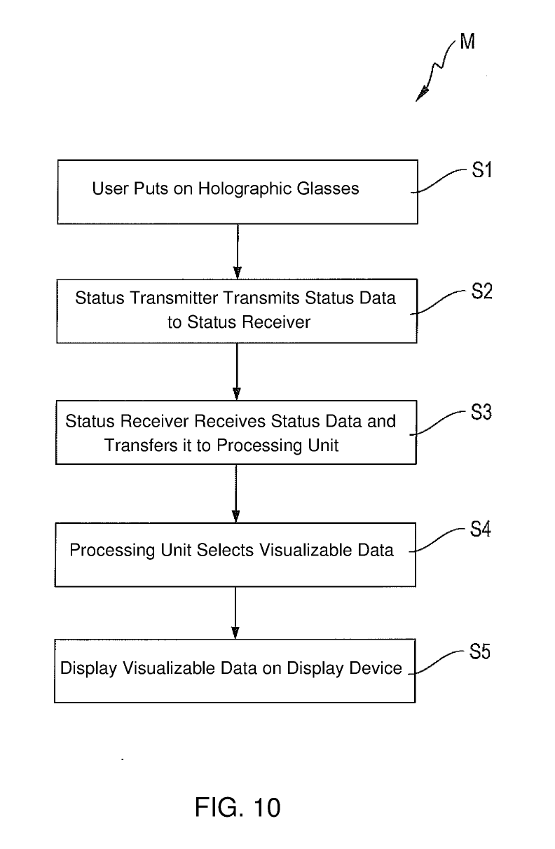

FIG. 10 shows an embodiment of a method according to the invention.

### Unless otherwise stated, the same reference signs are used below to denote identical and equivalent elements.

FIG. 1a shows a first embodiment of a display device. The display device 1 is a non-transparent display. In order for the user 2 to orientate himself spatially, the display device also comprises a camera (not shown), the image from which is displayed on the display 1. Additional, virtual objects can be displayed on the display 1 in addition to that which the user 2 would see without display 1.

FIG. 1b illustrates a second embodiment of a display device in the form of a pair of holographic glasses, as proposed in US2014/0160001 A1, for example. The display device 3 has two lenses 4, which are transparent and can additionally display virtual objects. An inward-facing sensor 5 monitors the eyes of the user in order to determine a gaze direction. An outward-facing sensor 6 captures the field of vision of the user, for instance in order to identify gestures. A status receiver 7 is arranged on the glasses. Data representing, for example, a reference status of the household appliance can be stored in a memory unit 8. On the basis of the received status data, a processing unit 9 can select and/or create visualizable data. In addition, the glasses comprise a loudspeaker 10 in order to provide information that can also be heard by the user.

FIG. 1c shows a third embodiment of a display device 11 in the form of a smart contact lens. This comprises a top lens layer 12 and a bottom lens layer 13, between which are arranged an antenna 14, a capacitor 15, a sensor 16 and a processing unit 17. The contact lens is capable of displaying virtual objects in the field of vision of the user.

FIG. 2 shows a first example of an augmented field of vision of a user 2, who is wearing a display device in front of his eyes. The user 2 is looking at a kitchen containing, amongst other items, a refrigerator 18, an oven 19, a cooktop 20, an extractor hood 21 and a dishwasher 22. Inside the oven 19 is a camera (not shown) in order to be able to display in the field of vision an image of the oven interior as visualizable data 23. Additional visualizable data 24 is displayed above the cooktop 20 as red lines in order to indicate to the user 2 that one of the hotplates is hot.

FIG. 3 shows a first embodiment of a system according to the invention. The system 25 comprises a camera 26, which can be arranged, for example, on the oven 19 shown in FIG. 2. The camera is connected to a status transmitter 27. This radio-transmits the status data to the status receiver 7 of the display device 3. As was already explained with reference to FIG. 1b, the glasses comprise a processing unit 9, which on the basis of the received status data can select or create visualizable data in order then to display this data in the glasses.

It is possible both to display the visualizable data when the user is looking at the associated household appliance and to delay the display until this is requested by a corresponding gesture. A possible gesture is illustrated in FIG. 4. In this case, the user is using his hand 28 to form an aperture 29, through which the oven 19 can be seen. The display device thereby detects that the status data from the oven 19 is meant to be displayed, insofar as status data for the oven 19 is available. FIG. 5 shows an alternative gesture. The hand 28 is formed into a gesture that has been fixed in advance with the system to represent the oven 19. Irrespective of the field of vision of the user, the visualizable data 23 showing the interior of the oven 19 is now displayed in the field of vision of the user. It is thus possible to interpret a gesture both in combination with the field of vision and independently of the field of vision.

If all the visualizable data on all the viewed household appliances is displayed without a gesture, the situation shown in FIG. 6 can arise in which a plurality of household appliances at once are providing the user with their information. Depending on the disposition of the user, this can be found comfortable or else annoying. The refrigerator 18 informs the user, for example, that milk should be purchased. The extractor hood 21 invites the user to clean the filter, and the dishwasher 22 reminds the user to take out the newly washed and subsequently dried dishes.

FIG. 7 shows another example. The user is looking at a vacuum cleaner 30, and is reminded by the display device to please replace the dust bag. Yet another example shall be explained with reference to FIGS. 8a and 8b. In FIG. 8a, the user is looking at a coffee machine 31 and is asked to refill the coffee beans and to empty the coffee dregs container. FIG. 8b shows the system that facilitates this augmenting of the field of vision of the user. The second embodiment of a system 32 according to the invention, which embodiment is shown in FIG. 8b, comprises a light curtain 33, which is arranged on a supply container 34 for coffee beans. Since the fill level of the coffee beans is low, the light curtain 33 signals that the coffee should be replenished. Another light curtain 35 is arranged on the coffee dregs collecting container 36 and detects that the coffee dregs container should be emptied. The status transmitter 27 sends this information to the status receiver 37, which is connected to a processing unit 38 in the network. The processing unit 38 selects or creates visualizable data on the basis of the received status data. This visualizable data is then sent to the display device 3.

FIG. 9 shows a dishwasher 22 with its door open. Since in the example shown, both salt and rinse aid are empty and the filter needs cleaning, operating instructions are shown to the user by means of the display device. The user is shown by the image 39 how to add the salt. The image 40 explains how to add the rinse aid, and the image 41 shows how to clean the filter.

FIG. 10 illustrates an embodiment of a method according to the invention for simplifying operation of a household appliance. According to the method M, in step S1, the user of the household appliance first puts on a pair of holographic glasses. In step S2, the status transmitter of the household appliance transmits status data to the status receiver. In step S3, the status receiver receives the status data and transfers it to the processing unit. Then in step S4, on the basis of the received status data, the processing unit selects appropriate visualizable data, which is then displayed on the display device in step S5.

The explanations made with reference to the figures are purely illustrative and shall not be considered limiting. Numerous modifications can be made to the embodiments shown without departing from the scope of protection of the invention as defined in the accompanying claims.

### LIST OF REFERENCES

1 display device

2 user

3 display device

4 lens

5 inward-facing sensor

6 outward-facing sensor

7 status receiver

8 memory unit

9 processing unit

10 loudspeaker

11 display device

12 top lens layer

13 bottom lens layer

14 antenna

15 capacitor

16 sensor

17 processing unit

18 refrigerator

19 oven

20 cooktop

21 extractor hood

22 dishwasher

23 visualizable data

24 visualizable data

25 first embodiment of a system according to the invention

26 camera

27 status transmitter

28 hand

29 aperture

30 vacuum cleaner

31 coffee machine

32 second embodiment of a system according to the invention

33 light curtain

34 coffee supply container

35 light curtain

36 coffee dregs collecting container

37 status receiver

38 processing unit

39 image explaining how to add salt

40 image explaining how to add rinse aid

41 image explaining filter cleaning

M embodiment of a method according to the invention

S1 putting on a pair of holographic glasses

S2 status transmitter of the household appliance transmitting status data

S3 status receiver receiving status data

S4 processing unit selecting visualizable data

S5 displaying the visualizable data on the display device

1-15 (canceled).

16. A system for simplifying operation of a household appliance, the system comprising:
a status transmitter for transmitting status data describing at least one aspect of a status of the household appliance;
a status receiver for receiving the status data from said status transmitter;
a processing unit for selecting or creating visualizable data based on the received status data; and
a display device configured to be placed in front of an eye of a user of the system and to display the visualizable data.

17. The system according to claim 16, which further comprises a sensor system for detecting at least one aspect of the status of the household appliance, said sensor system being coupled to said status transmitter.

18. The system according to claim 17, wherein said sensor system includes at least one of a camera, a barcode scanner, a temperature sensor, a humidity sensor, a microphone, an ultrasonic sensor, an accelerometer, a momentary-contact switch, a light curtain or a level indicator.

19. The system according to claim 17, wherein at least one of said status transmitter or said sensor system are configured to be placed in or on the household appliance or are connected to the household appliance.

20. The system according to claim 16, which further comprises an input device for entering at least one aspect of the status of the household appliance.

21. The system according to claim 20, wherein said input device is coupled to said status transmitter.

22. The system according to claim 16, which further comprises:
a memory unit coupled to said processing unit for storing a reference status of the household appliance;
said processing unit being configured to compare the received status data with reference status, and to select or create the visualizable data bases on a comparison result.

23. The system according to claim 16, wherein said display device is configured to identify a gaze direction of the user, and to display the visualizable data with reference to a normal field of vision of the user to permit the user to recognize that the visualizable data belongs to the household appliance.

24. The system according to claim 16, wherein at least one of said display device or said processing unit are configured to recognize a gesture of the user, and the visualizable data depends on a recognized gesture.

25. The system according to claim 16, wherein said display device is formed of a pair of glasses or a contact lens being at least partially transparent, or said display device includes a non-transparent display and a camera.

26. The system according to claim 16, wherein the household appliance is a refrigerator, and the visualizable data relates to food not currently in the refrigerator and therefore meant to be bought by the user.

27. The system according to claim 16, wherein the household appliance is a cooktop, and the visualizable data relates to a hot zone of the cooktop.

28. The system according to claim 16, wherein the household appliance is an oven, and the visualizable data relates to an image of an interior of the oven.

29. The system according to claim 16, wherein the household appliance is an extractor hood, and the visualizable data relates to maintenance advice.

30. The system according to claim 16, wherein the household appliance is a dishwashing machine or a washing machine, and the visualizable data indicates a cleaning process being finished or relates to maintenance advice.

31. The system according to claim 16, wherein the visualizable data relates to a fill level of an operating medium or to a fill level of a waste container.

32. The system according to claim 31, wherein the operating medium is a cleaning agent or coffee.

33. The system according to claim 31, wherein the waste container is a dust bag or a coffee dregs collecting container.

34. A method for simplifying operation of a household appliance, the method comprising the following steps:
placing a display device in front of an eye of a user of the household appliance;
transmitting status data describing at least one aspect of a status of a household appliance to a status receiver;
selecting or creating visualizable data based on the status data received by the status receiver; and
displaying the visualizable data on the display device.

35. A method for simplifying operation of a household appliance using a system according to claim 1, the method comprising the following steps:
placing a display device in front of an eye of a user of the household appliance;
transmitting status data describing at least one aspect of a status of a household appliance to a status receiver;
selecting or creating visualizable data based on the status data received by the status receiver; and
displaying the visualizable data on the display device.
